(19) United States
(12) Patent Application Publication
(10) Pub. No.: US 2008/0063166 A1
(43) Pub. Date: Mar. 13, 2008

(54) Visual caller identification system and method for audiovisual telephony system

(75) Inventors: Dae Won An, Gumi-si (KR); Min Hong Park, Busan-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/827,344

(22) Filed: Jul. 11, 2007

(30) Foreign Application Priority Data
Sep. 8, 2006 (KR) 2006-0087068

(51) Int. Cl. H04M 1/56

(52) U.S. Cl. 379/142.04

(57) ABSTRACT

A visual caller identification system and method are provided for an audiovisual telephony system. A visual caller identification method for an audiovisual telephony system having a calling party terminal and a called party terminal includes transmitting a caller picture from the calling party terminal to the called party terminal before establishing an audiovisual telephony channel between the two terminals, determining whether a connection request is generated at the called party terminal and establishing the audiovisual telephony channel between the two terminals if a connection request is generated at the called party terminal.

### CLAIM OF PRIORITY

This application claims the benefit of the earlier filing date, pursuant to 35 USC 119, to that patent application entitled “VISUAL CALLER IDENTIFICATION SYSTEM AND METHOD FOR AUDIOVISUAL TELEPHONY SYSTEM,” filed in the Korean Intellectual Property Office on Sep. 8, 2006 and assigned Serial No. 2006-0087068, the contents of which are incorporated herein by reference.

### BACKGROUND OF THE INVENTION

1. Field of the Invention

The present invention relates to an audiovisual telephony system and, in particular, to a caller identification system and method for an audiovisual telephony system.

2. Description of the Related Art

In order to provide a video conference telephony service in a mobile environment, a wide bandwidth (over 64 Kbps and improved processing capability capable of encoding video data (over 5 frames per second) are required. A typical voice bandwidth is in the order of 12.2 Kbps. Such large bandwidth and processing capability were not satisfied until 3^{rd} generation (3G) mobile communication systems emerged. Code Division Multiple Access (CDMA) is the foundation for 3G systems. There are two dominant International Mobile Telecommunications-2000 (IMT-2000) standards: synchronous CDMA 2000 and asynchronous Wideband CDMA (WCDMA). Audiovisual telephony protocol depends on such 3G systems.

For example, 3G-324M is a protocol for audiovisual telephony in WCDMA and has been adopted by the 3^{rd} Generation Partnership Project (3GPP). Alternatively, H.324M is an international standard for multimedia communication over low bit-rate networks, including 3G mobile networks. H.324M terminals provide real-time video, audio, data, or any combination thereof, between two multimedia terminals such that a called party and a calling party can communicate while viewing each other on screens. However, video telephony may cause a privacy problem. For example, when a wrong call is received, a called party's face can be exposed to an unexpected stranger or to a person with whom the called party does not want to communicate, resulting in privacy intrusion.

### SUMMARY OF THE INVENTION

The present invention has been made in an effort to solve the above problems and provides additional advantages, by providing a visual caller identification system and method for an audiovisual telephony system that enable a called party to visually identify a calling party together with an alarm before receiving an incoming call.

It is another aspect of the present invention to provide a visual caller identification system to provide a visual caller identification system and method for an H.324M terminal that allow a called party to selectively receive an incoming call by visually identifying a calling party before a call establishment.

In accordance with an aspect of the present invention, a visual caller identification method for an audiovisual telephony system includes a calling party terminal and a called party terminal. The visual caller identification method of the present invention includes transmitting a caller picture, input in real-time to the calling party terminal, from the calling party terminal to the called party terminal before establishing an audiovisual telephony channel between the two terminals, determining whether a connection request is generated at the called party terminal and establishing the audiovisual telephony channel between the two terminals when a connection request is generated at the called party terminal.

Transmitting a caller picture includes configuring a virtual terminal for emulating the called party terminal, establishing a virtual audiovisual telephony channel between the calling party terminal and the virtual terminal, transmitting the caller picture from the calling party terminal to the virtual terminal and forwarding the caller picture to the called party terminal.

Establishing a virtual audiovisual telephony channel includes determining whether the called party terminal is configured to enable a visual caller identification function and configuring, if the called party terminal is not configured, the visual caller identification function.

The virtual terminal is configured at a base station connected to the called party terminal.

The audiovisual telephony channel is established in accordance with an H.324M protocol.

In accordance with another aspect of the present invention, a visual caller identification method for an H.324M audiovisual telephony system includes a calling party terminal and a called party terminal. The visual caller identification method includes activating a virtual terminal between the calling party and called party terminals, establishing a connection between the calling party terminal and the virtual terminal when the calling party terminal requests to make a call to the called party terminal, forwarding, at the virtual terminal, a caller picture and information received from the calling party terminal to the called party terminal and establishing an audiovisual telephony channel between the calling party and called party terminals when a call request is received in response to the caller picture.

The virtual terminal is located at a base station connected to the called party terminal.

In accordance with another aspect of the present invention, a visual caller identification method for an H.324M audiovisual telephony system includes a calling party terminal and a called party terminal. The visual caller identification method includes transmitting a caller picture, input in real-time to the calling party terminal, and calling party information provided by the calling party terminal from the calling party terminal to the called party terminal before establishing an audiovisual telephony channel between the two terminals, determining whether a connection request is generated at the called party terminal in response to the caller picture according to a user decision signal and establishing the audiovisual telephony channel between the two terminals if a connection request is generated.

The visual caller identification method further includes configuring a virtual terminal for receiving and forwarding the caller picture to the called party terminal.

Configuring a virtual terminal includes transmitting, at the called party terminal, a configuration request signal to a base station and radio network controller associated with the called party terminal, enabling the virtual terminal in cooperation with the base station and radio network controller and receiving a configuration complete signal from the base station and radio network controller.

In accordance with another aspect of the present invention, a visual caller identification system for an audiovisual telephony system includes a calling party terminal and a called party terminal. The visual caller identification system includes a configuration part for configuring a virtual terminal, a relay part for receiving a caller picture received from the calling party terminal and forwarding the caller picture to the called party terminal and a channel establishment part for establishing, when a connection request is received from the called party terminal, an audiovisual telephony channel between the calling party and called party terminals.

In accordance with another aspect of the present invention, a visual caller identification system for an H.324M audiovisual telephony system includes a base station, a radio network controller, a calling party terminal, and a called party terminal. The visual caller identification system includes a virtual terminal configured at the base station for emulating the called party terminal. The virtual terminal includes a relay module for forwarding a caller picture received from the calling party terminal to the called party terminal and a channel establishment part for establishing, if a connection request is received from the called party terminal in response to the caller picture, an audiovisual telephony channel between the calling party and called party terminals.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of an exemplary WCDMA mobile communication system;

FIG. 2 is a message flow diagram illustrating a visual caller identification method for an audiovisual telephony system according to an embodiment of the present invention; and

FIG. 3 is a flowchart illustrating a visual caller identification method for an audiovisual telephony system according to an embodiment of the present invention.

### DETAILED DESCRIPTION OF THE INVENTION

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

In the present invention, a virtual H.324 terminal is introduced, which is set by a base station (BS) or a Radio Network Controller (RNC). The virtual H.324M terminal is connected to a calling party H.324M terminal and then calls a called party H.324M terminal with a caller's picture and/or caller's information such that the called party can identify the caller with the picture displayed on a screen. Accordingly the called party can selectively receive the incoming calls by visually identifying the calling party with the calling party picture transmitted by the virtual H.324M terminal.

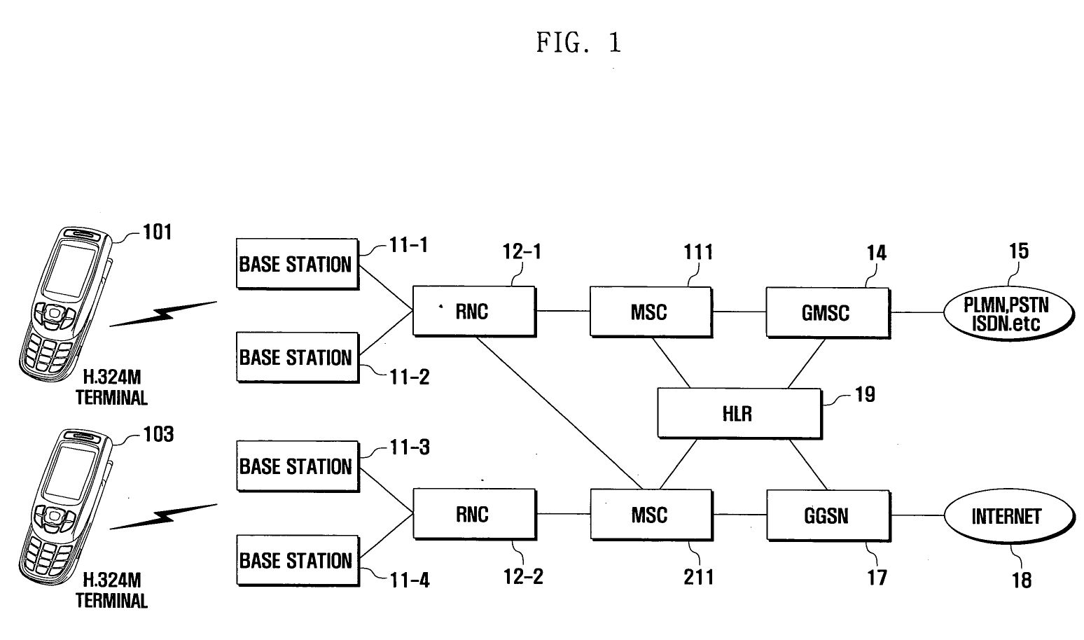

FIG. 1 is a block diagram illustrating a configuration of an exemplary WCDMA mobile communication system.

Referring to FIG. 1, the WCDMA mobile communication system includes a plurality of base stations (BSs) 11-1 to 11-4 for connecting a plurality of H.324M terminals 101 and 103 to Radio Network Controllers (RNCs) 12-1 and 12-2, respectively.

The RNCs 12-1 and 12-2 are responsible for connecting the wireless networks defined by the RNCs and BSs 11-1 to 11-4 to a core network (CN).

The RNCs 12-1 and 12-2 are connected to Mobile Switching Centers (MSCs) 111 and 211, respectively, that provide a circuit-switched service and manage mobility of the mobile terminals for maintaining connectivity of the mobile terminals at most places and times. The MSCs 111 and 211 are connected to a, Home Location Register (HLR) 19, and to a Gateway Mobile Switching Center (GMSC) 14, or a Gateway GPRS support Node (GGSN) 17.

A GMSC 14 is responsible for connecting to a circuit switched network such as a Public Land Mobile Network (PLMN), Public Switched Telephone Network (PSTN), Integrated Service Digital Network (ISDN), etc. for the circuit-switched services. The GGSN 17 connects a GPRS network to an external packet data network 18 such as the Internet.

The HLR 19 is a database for providing routing information of the H.324M terminals 101 and 103 and is responsible for maintenance of user subscription information.

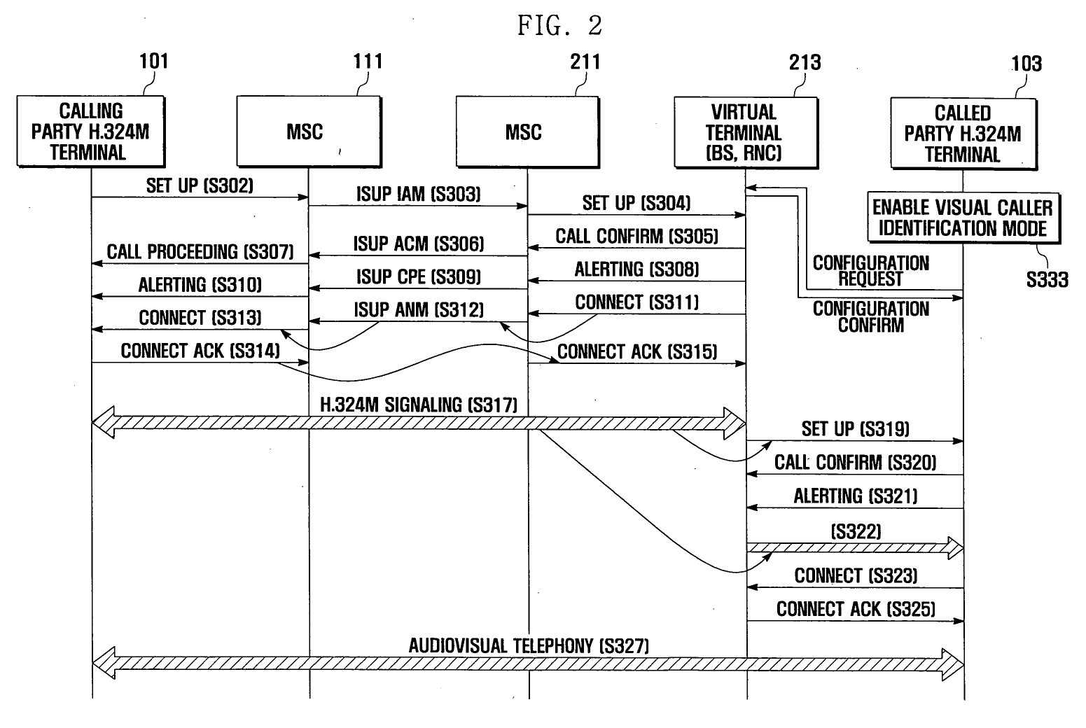

FIG. 2 is a message flow diagram illustrating a visual caller identification method for an audiovisual telephony system according to an embodiment of the present invention.

In this embodiment, it is assumed that the first H.324M terminal 101 is a calling party terminal, the second H.324M terminal 103 is a called party terminal, MSC 111 is servicing the calling party, and MSC 211 is servicing the called party.

Each of the calling party and called party H.324M terminals 101 and 103 has a display and camera for supporting the video telephony together with a video processing function.

In this exemplary embodiment, if the called party H.324M terminal 103 is set for supporting a visual caller identification function, the RNC 12-2 is set for supporting the visual caller identification function by the BS 11-4. In this case, the BS 11-4 and RNC 12-2 operate as a virtual H.324M terminal 213.

If an outgoing call is requested by a calling party, the calling party H.324M terminal 101 transmits a call setup request message (SETUP) to the calling party MSC 111 through the BS 11-1 and the RNC 12-1 (S302). Upon receiving the call setup request message, the calling party MSC 111 transmits an initial address message (ISUP IAM) to the called party MSC 211 (S303). The called party MSC 211 transmits the SETUP to the virtual H.324M terminal 213 (S304). Upon receiving the SETUP, the virtual H.324M terminal 213, which represents a proxy of the called party, transmits a call confirmation message (CALL CONFIRM) to the called party MSC 211 (S305). The called party MSC 211 transmits an acknowledgement message (ISUP ACM) to the calling party MSC 111 in response to the ISUP IAM (S306) and the calling party MSC 111 transmits a call proceeding message (CALL PROCEEDING) to the calling party H.324M terminal 101 (S307).

After transmitting the CALL CONFIRM, the virtual H.324M terminal 213 transmits an alerting message (ALERTING) to the called party MSC 211 (S308). When the ALERTING message is received, the called party MSC 211 transmits a message (ISUP CPG) to the calling party MSC 111 (S309). The calling party MSC 111 then transmits the response to the ALERTING message to the calling party H.324M terminal 101 (S310).

Following transmission of the ALERTING message at step S308, the virtual H.324M terminal 213 transmits a connection request message (CONNECT) to the called party MSC 211 (S311) and the called party MSC 211 transmits, upon receiving the CONNECT, an answer message (ISUP ANM) to the calling party MSC 111 (S312). When the ISUP ANM is received, the calling party MSC 111 transmits the CONNECT to the calling part H.324M terminal (S313).

In response to the CONNECT, the calling party H.324M terminal 101 transmits a connection acknowledgement message (CONNECT ACK) through to the called party MSC 211 via the calling party MSC 111 (S314) and thence to the virtual H.324M terminal 213, such that a connection is established between the calling party H.324M terminal 101 and the virtual H.324M terminal 213. After the connection is established, the H.324M terminal 101 provides the virtual H.324M terminal 213 with a calling party picture and information through an H.324M signaling procedure (S317).

During the H.324M signaling procedure, the calling party H.324M terminal 101 is not connected with the called party H.324M terminal 103. However, the calling party H.324M terminal 101 can proceed with the video telephony with the virtual H.324M terminal 213 such that the calling party picture data can be transmitted to the virtual H.324M terminal 213 in addition to a voice signal.

After the calling party H.324M terminal 101 is connected to the virtual H.324M terminal 213, the virtual H.324M terminal 213 transmits a setup request message (SETUP) to the called party H.324M terminal 103 (S319). A confirmation message (CALL CONFIRM) is sent by the called party H.324M terminal 103 in response to the SETUP message (S320), and an alerting message (ALERTING) is sent by the called party H.324 terminal 103 following the CALL CONFIRM message (S321), are received by the virtual H.324M terminal 213, the virtual H.324M terminal 213 forwards the calling party picture and voice data to the called party H.324M terminal 103 in real time (S322). Accordingly, the called party can decide whether to receive the call by identifying the calling party on the basis of the calling party picture and voice data.

When the CONNECT message is transmitted to the virtual H.324M terminal 213 by called party key manipulation (for example, a “send” key is pushed by the called party) (S323) or when the visual image matches a library of predefined visual images, the virtual H.324M terminal 213 transmits the connection acknowledge message CONNECT ACK to the called party H.324M terminal 103 (S325) such that audiovisual telephony channel is directly established between the calling party and called party H.324M terminals 101 and 103 (S327).

In this embodiment, the visual caller identification system is described with a virtual H.324M terminal configured as a called party network. In this case, the visual caller identification of the present invention can be implemented for the calling party H.324M terminal by setting the virtual H.324M terminal at a calling party network.

Since the above-mentioned messages “ISUP IAM”, “ISUP ACM”, “ISUP CPg”, and “ISUP ANM” are defined in “Call Setup procedure for General Mobile to Mobile 3G-324M” recommended in “3G TR 23.972 V3.00,” detailed descriptions of these messages are omitted.

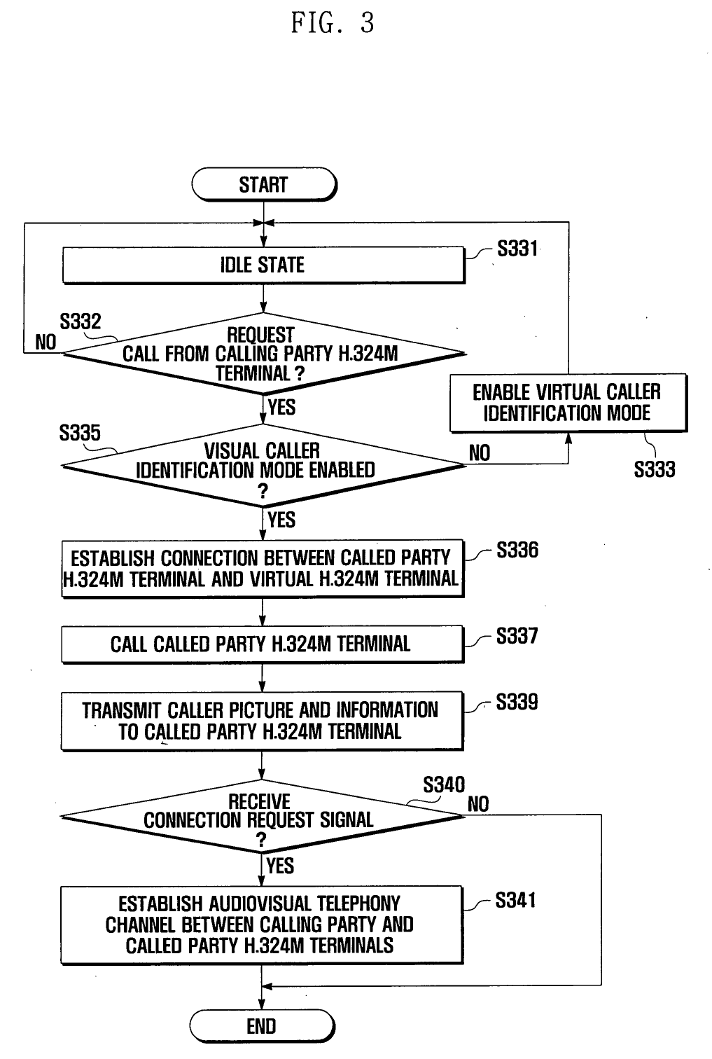

FIG. 3 is a flowchart illustrating a visual caller identification method for an audiovisual telephony system according to an embodiment of the present invention. In this visual caller identification method, a virtual H.324M terminal establishes a call setup with the calling party H.324M terminal and provides a calling party picture and information to an H.324M terminal associated with the called party such that the called party can decide whether to receive the call after identifying the calling party.

The visual caller identification method includes configuring a virtual H.324M terminal at a called party base station, connecting, when an incoming call is received, a calling party H.324M terminal to the virtual H.324M terminal; and establishing direction connection between the calling party H.324M terminal and a called party H.324M terminal when a connection is confirmed by the called party after identifying the calling party on the basis of a calling party picture and information provided by the virtual H.324M terminal.

In order to implement a visual caller identification system, a virtual H.324M terminal 213 is enabled at a called party network (S333). In FIG. 2, it is assumed that the base stations 11-1 to 11-2 and the RNC 12-1 are configured to operate as a virtual H.324M terminal for the H.324M terminal 101 and the base stations 11-3 and 11-4 and the RNC 12-2 are configured to operate as a virtual H.324M terminal for the H.324M terminal (103).

Referring to FIGS. 1 and 3, in an idle mode (S331), the virtual H.324M terminal 213 determines whether a call request is received from the calling party H.324M terminal 101 (S332). If a call request is received from the calling party H.324M 101, the virtual H.324M terminal 213 determines whether a visual caller identification mode is enabled (S335). If a visual caller identification mode is not set, the virtual H.324M terminal 213 sets the visual caller identification mode (see FIG. 2) (S333). If a visual caller identification mode is enabled, the virtual H.324M terminal 213 establishes an audiovisual telephony channel with the called party H.324M terminal 103 through an H.324M signaling procedure including a call setup and alarm signaling (S336).

The virtual H.324M terminal 213 then calls the called party H.324M terminal 103 (S337). That is, the virtual H.324M terminal 213 transmits a call setup request to the called party H.324M terminal 103, and the called party H.324M terminal 103 transmits a call confirmation and alarm signal to the virtual H.324M terminal 213 in response to the call setup request.

Upon receiving the call confirmation and alarm signal, the virtual H.324M terminal 213 transmits a calling party video stream input through a camera of the calling party H.324M terminal 101 and caller information to the called party H.324M terminal 103 (S339). Next, the virtual H.324M terminal 213 determines whether a connection request is received from the called party H.324M terminal 103 (S340). The connection request is generated at the called party H.324M terminal 103 depending on the called party's decision whether to receive the call after viewing the calling party picture.

When a connection request is received, the virtual H.324M terminal 213 connects the calling party H.324M terminal 101 and the called party H.324M terminal 103 through a direct audiovisual communication channel (S341).

In this embodiment, a visual caller identification is described, however, the identification mechanism can be used for a called party identification by configuring a virtual H.324M terminal at the calling party network.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A visual caller identification method for an audiovisual telephony system including a calling party terminal and a called party terminal, comprising the steps of:
transmitting a caller picture, input in real-time to the calling party terminal, from the calling party terminal to the called party terminal before establishing an audiovisual telephony channel between the two terminals;
determining whether a connection request is generated at the called party terminal; and
establishing the audiovisual telephony channel between the two terminals when a connection request is generated at the called party terminal.

2. The visual caller identification method of claim 1, wherein the step of transmitting a caller picture comprises the steps of:
configuring a virtual terminal for emulating the called party terminal;
establishing a virtual audiovisual telephony channel between the calling party terminal and the virtual terminal;
transmitting the caller picture from the calling party terminal to the virtual terminal; and
forwarding the caller picture to the called party terminal.

3. The visual caller identification method of claim 2, wherein the step of establishing a virtual audiovisual telephony channel comprises the step of:
enabling, if the called party terminal is not enabled, the visual caller identification function.

4. The visual caller identification method of claim 1, wherein the virtual terminal is configured at a base station to which the called party terminal is connected.

5. The visual caller identification method of claim 1, wherein the audiovisual telephony channel is established in accordance with an H.324M protocol.

6. A visual caller identification system for an H.324M audiovisual telephony system including a base station, a radio network controller, a calling party terminal, and a called party terminal, comprising:
a virtual terminal configured in the base station for emulating the called party terminal, wherein the virtual terminal comprises:
a relay module for forwarding a caller picture received from the calling party terminal to the called party terminal; and
a channel establishment part for establishing, when a connection request is received from the called party terminal in response to the caller picture, an audiovisual telephony channel between the calling party and called party terminals.

7. A method for establishing a telephonic connection between a first and a second party, the method comprising the steps of:
transmitting, from a terminal associated with the first party, a visual image of the first party to a proxy terminal of the second party; and
establishing the telephonic connection when the first party terminal receives a call request from the second party terminal.

8. The method of claim 7, wherein the step of transmitting a visual image comprises the steps of:
establishing a audiovisual telephony channel between the terminal associated with the first party and the proxy terminal;
transmitting the first party picture from the first party to the proxy terminal; and
forwarding the caller picture to the terminal associated with the second party.

9. The method of claim 8, wherein the visual image is prestored.

10. The method of claim 8, wherein the visual image is obtained in real-time.

11. The method of claim 8, wherein in the call request is transmitted after the visual image is provided to the second party.

12. The method of claim 11, wherein the call request is generated manually by the second party.

13. The method of claim 11, wherein the call request is generated when said visual image matches an image in a predefined library of images.

14. The method of claim 11, wherein the call request is transmitted via the proxy terminal.

15. A calling party apparatus for establishing a visual telephone connection to called party, the apparatus comprising:
means for establishing a connection to a proxy terminal of the called party;
means for providing a visual image of the calling party to the proxy terminal; and
means for establishing a visual connection to the called party in response to a call request message received via the proxy terminal.

16. The apparatus of claim 15, wherein the calling party image is obtained in real-time.

17. The apparatus of claim 16, wherein the calling party image is predetermined.
